(19) United States
(12) Patent Application Publication
(10) Pub. No.: US 2023/0177222 A1
(43) Pub. Date: Jun. 8, 2023

(54) PROTECTING A MEASUREMENT SYSTEM FROM UNAUTHORIZED CHANGES

(71) Applicant: Advantest Corporation, Tokyo (JP)

(72) Inventors: Bernd BETERKE, Aspach (DE); Piotr SKWIERAWSKI, Frankenthal (DE); Petra FUNKE, Aidlingen (DE); Roland FRIEDRICH, Winnenden (DE)

(21) Appl. No.: 18/162,702

(22) Filed: Jan. 31, 2023

Related U.S. Application Data
(63) Continuation of application No. PCT/EP2020/081538, filed on Nov. 9, 2020.

(51) Int. Cl. G06F 21/82; G06F 21/64; G06F 21/60

(52) U.S. Cl. CPC G06F 21/82; G06F 21/64; G06F 21/602

(57) ABSTRACT

The disclosure describes a method of protecting a measurement system from unauthorized changes. The method comprises automatically reading out a plurality of information items from the measurement system, wherein the measurement system comprises a plurality of measurement system components and at least one local storage device, wherein the plurality of information items include at least one of identity of the measurement system components or at least one characteristic of the measurement system components; automatically combining the read out information items of each of the plurality of the measurement system components into a data collection and generating a summary data which represents the data collection; creating a signature based on the summary data; and storing the summary data and the signature in the at least one local storage device of the measurement system. This method provides more efficient and secure protection of measurement system and its components from an unauthorized change.

### CROSS-REFERENCE TO RELATED APPLICATION

This application is a continuation of copending International Application No. PCT/EP2020/081538, filed Nov. 9, 2020, which is incorporated herein by reference in its entirety.

### TECHNICAL FIELD

Embodiments according to the disclosure are concerned with protecting measurement systems from unauthorized changes and checking an integrity of measurement systems.

Embodiments according to the disclosure are related to a method of protecting a measurement system, including a plurality of measurement system components and at least one local storage device, from unauthorized changes.

Further embodiments according to the disclosure are related to a method of checking an integrity of a measurement system comprising a plurality of measurement system components and at least one local storage device.

Further embodiments according to the disclosure are related to a method of controlling operation of a measurement system including a plurality of measurement system components and at least one local storage device, where the method includes protecting the measurement system from unauthorized changes and checking an integrity of the measurement system.

Further embodiments according to the disclosure are related to a measurement system including a plurality of measurement system components and at least one local storage device.

Further embodiments according to the disclosure are related to a computer-readable storage device including a plurality of computer-executable instructions stored therein for performing methods of protecting a measurement system from unauthorized changes and checking an integrity of the measurement system.

The disclosure can be applied to protecting calibration equipment used to calibrate production equipment.

### BACKGROUND

A multitude of methods of checking an integrity of measurement systems to ensure that no unauthorized changes were made to the measurement systems exist.

These methods, however, usually use manual check of coherence measurement systems and of calibration status of the coherence measurement systems and their separate components. The outcome of these methods usually highly depends on a human factor and on the completeness of the information in a traceability documentation of used measurement equipment. This makes corresponding checking procedures not only difficult and time-consuming but also leads to errors in measurements due to incompleteness of the documentation or incorrect calibration of the measurement equipment.

In view of the above, there is a desire to create a method which enables an improvement of the reliability (or trustworthiness) of a measurement system in an efficient manner, for example, by allowing a reporting of any unauthorized changes to the measurement system or its separate components, leading to an improved operation of the measurement systems.

Accordingly, there is a desire to provide a capability, which is more efficient in view of an efficiency of an integrity check of the measurement system and protection of the measurement system from unauthorized changes.

### SUMMARY

An embodiment according to the disclosure is directed to a method of protecting a measurement system, including a plurality of measurement system components (e.g., at least one of voltage meter, frequency meter, temperature meter, humidity meter, cable, power divider, relay, passive component, smart device which has a built-in functionality to report one or more information items uniquely identifying the smart device, or manual device which does not have a built-in functionality to report information items to uniquely identify the manual device but is arranged with a local storage device configured to store such information items uniquely identifying the manual device) and at least one local storage device, from unauthorized changes. The method includes: automatically reading out (e.g., using a read out mechanism) a plurality of information items (e.g., information items uniquely identifying (e.g., a type identifier and/or a serial number) the measurement system components, and/or information items representing one or more characteristics (e.g., a software revision, a calibration date, and/or a calibration interval) of the measurement system components); automatically combining (e.g., using a combiner) the read out information items (e.g., a serial number, a type identifier, a software revision, a calibration date, a calibration interval, etc.,) of each (or at least of some) of the plurality of the measurement system components into a data collection and generating summary data (e.g., a summary file) which represents the data collection; creating a signature based on the summary data; and storing the summary data and the signature in the at least one local storage device of the measurement system.

This embodiment is based on the finding that an integrity of the measurement system can be ensured (e.g., checked later on) by collecting sufficient information of the measurement system and of its separate components and protecting the collected information from unauthorized changes by signing the collected information.

According to an embodiment, creating the signature includes signing the summary data with a private key. The security of the data protection is thus improved. Also, a check of the integrity of the summary data is possible using a public key, which allows for a very reliable implementation. In particular, the concept allows any third party having access to the public key corresponding to the private key to check the integrity.

According to an embodiment, the private key is a confidential private key. The security of the data protection is further improved due to a confidentiality of the private key.

According to an embodiment, the summary data and the signature are stored in two separate files (e.g., summary file and signature file). In another embodiment, the summary data and the signature are stored in one file.

According to an embodiment, one or more of the measurement system components which do not have a built-in functionality to report information items to uniquely identify the respective measurement system components (e.g., measurement system components which are configured to be read manually and not automatically or which are not tracked automatically, such as passive measurement system components (e.g., cables, switches, relays, power splitters, shielding equipment, connectors, adaptors, or older measurement devices which do not allow for automatic readout of a unique identifier such as a serial number via an external communication interface)) are arranged with local storage devices of the measurement system to enable automatically reading out measurement system component specific information items identifying the measurement system components which do not have a built-in functionality to report information items to uniquely identify the respective measurement system components. Arranging these measurement system components with local storage devices that have communication interfaces allows automatic tracking of a state of the measurement system, which conventionally cannot be tracked automatically, thus enabling automatically reading out the information items identifying the measurement system components of the measurement system without involvement of a user. In particular, by using such a concept, it is possible to automatically detect an exchange of a passive component of the measurement system, which may degrade the functionality of the measurement system.

According to an embodiment, the method includes arranging the measurement system components which do not have a built-in functionality to report information items to, e.g., uniquely, identify the respective measurement system components with the associated local storage devices prior to automatically reading out the information items, e.g., uniquely, identifying the respective measurement system components. Automatic collecting of the parameters of all the components of the measurement system at the same time (or at least in a single process flow) during the reading out step is thus provided.

According to an embodiment, the measurement system components which do not have a built-in functionality to report information items to, e.g., uniquely, identify the respective measurement system components are inseparably combined or associated with associated local storage devices. This allows exchanging the respective measurement system component together with the respective local storage device and ensuring that automatic reading of all the components is enabled even upon replacing the respective component. In particular it is prevented that a measurement system component which does not have a built-in functionality to report information items is exchanged without noticing the change.

According to an embodiment, the measurement system components which do not have a built-in functionality to report information items to, e.g., uniquely, identify the respective measurement system components are combined or associated with respective associated local storage devices in such a manner that the measurement system components cannot be separated from the respective associated local storage devices in a toolless manner, or the measurement system components which do not have a built-in functionality to report information items to, e.g., uniquely, identify the respective measurement system components are combined or associated with respective associated local storage devices in such a manner that the measurement system components cannot be separated from the respective associated local storage devices in a nondestructive manner, or the measurement system components which do not have a built-in functionality to report information items to, e.g., uniquely, identify the respective measurement system components are combined or associated with respective associated local storage devices in such a manner that the measurement system components cannot be separated from the respective associated local storage devices without breaking a seal. This reliably prevents that a measurement system component which does not have a built-in functionality to report information items is exchanged without noticing the change, since high effort would be needed to relocate the local storage device.

According to an embodiment, at least one of the measurement system components which do not have a built-in functionality to report information items to, e.g., uniquely, identify the respective measurement system components is glued to a respective one of the local storage devices. This is a particularly efficient solution to prevent unauthorized exchange of the measurement system component.

According to an embodiment, at least one of the measurement system components which do not have a built-in functionality to report information items to, e.g., uniquely, identify the respective measurement system components is arranged in a separate housing, e.g., box, cover, with a respective one of the local storage devices. The separate hardware unit with a communication interface is thus provided, which comprises the measurement system component and the local storage device with the communication interface.

According to an embodiment, the one or more of respective local storage devices are one of the following: a USB storage device, a Network attached storage device, a wired-LAN storage device, a wireless-LAN storage device, or an RFID tag. These storage devices are some examples of the storage device which can be used. Any other storage device could be used in other embodiments.

According to an embodiment, the one or more measurement system components which do not have a built-in functionality to report information items to, e.g., uniquely, identify the respective measurement system components comprise one or more, e.g., active, measurement devices, e.g., measurement devices configured to report a measurement result via an external interface, e.g., to a measurement system controller. Particularly, the older measurement devices not having communication interfaces could be used.

According to an embodiment, the one or more measurement system components which do not have a built-in functionality to report information items to, e.g., uniquely, identify the respective measurement system components comprise one or more passive measurement system components, e.g., signal path components, passive switches, relays, attenuators, connectors, adaptors, cables, sensors. Reading out the information e.g., from memories attached to these passive measurement system components allows tracking the state of the measurement system as a whole and considering any fluctuations, e.g., voltage and resistance in the connection lines between the components. A change of passive components, which would degrade the system performance, becomes detectable.

According to an embodiment, the one or more measurement system components which do not have a built-in functionality to report information items to, e.g., uniquely, identify the respective measurement system components comprise one or more of the following measurement system components: signal path components, coupling components, couplers, adapters, or cables. Thus, a change of such components, which would degrade the system performance, becomes detectable.

According to an embodiment, the one or more measurement system components which do not have a built-in functionality to report information items to, e.g., uniquely, identify the respective measurement system components comprise one or more of the following measurement system components: thermodynamic components, fixed power supply components, antennas, shielding housing components, or cooling components, e.g., fans, e.g., allowing tracking aerodynamic characteristics of the fans. Thus, a change of such components, which would degrade the system performance, becomes detectable.

According to an embodiment, the method comprises automatically reading out information items identifying the one or more measurement system components which do not have a built-in functionality to report information items to, e.g., uniquely, identify the respective measurement system components from respective local storage devices (e.g., local memories, associated with the one or more measurement system components which do not have a built-in functionality to report information items to, e.g., uniquely, identify the respective measurement system components), and automatically including the read out information items, e.g., a serial number, a type identifier, a software revision, a calibration date, a calibration interval, etc., of the one or more measurement system components which do not have a built-in functionality to report information items to, e.g., uniquely, identify the respective measurement system components into the data collection. This allows for an automatic monitoring of many types of measurement system components.

According to an embodiment, the one or more characteristics of the measurement system components comprise a wear out condition of at least one of the measurement system components. This allows determining whether all the components of the measurements system function properly in order to avoid any measurement errors.

According to an embodiment, an information item identifying the wear out condition is a value of a counter which is arranged in a respective measurement system component, wherein one is added to the counter upon each use of the respective measurement system component (or, generally speaking, wherein the value is incremented or decremented for each usage or state change of the respective measurement system component). Thus, the memory associated with the respective measurement system component is re-used to also track a wear out of the respective measurement system component. By checking the wear out information, an expected unreliability of the measurement system can be identified.

According to an embodiment, the method further comprises performing a self-estimation, e.g., measuring one or more parameters, e.g., resistance measurement, e.g., for relays, of a respective measurement system component to determine the wear out condition of the respective component. Consequently, a reliability of the measurement system can be increased by detecting fault conditions of the measurement system.

According to an embodiment, the method further comprises obtaining (e.g., reading from the user interface, reading from a memory associated with a measurement system component, collecting, or automatically obtaining), information on allowable, e.g., optimal, operating environmental conditions (e.g., an allowable temperature range and/or an allowable humidity range and/or an allowable maximum electromagnetic interference used in calibration of the measurement system by the manufacturer, or deviating from environment conditions used in calibration of the measurement system by no more than an allowable tolerance) for the measurement system; and storing the information on the allowable, e.g., optimal, operating environmental conditions in the at least one local storage device of the measurement system. This allows to avoid unknown effect of the environmental conditions, such as too high or too low temperatures, extreme humidity level and/or unknown effects of electromagnetic influence. When using the measurement system, it is possible to check whether actual measurement conditions are in agreement with the allowable operating environmental conditions. The information on the allowable operating environmental conditions may be signed, e.g., a signature may be created and stored, e.g., in the at least one local storage device of the measurement system.

According to an embodiment, the information on allowable, e.g., optimal, operating environmental conditions comprises information on a humidity and/or a temperature and/or an electromagnetic interference.

An embodiment according to an disclosure creates a method for checking an integrity of a measurement system comprising a plurality of measurement system components (e.g., one or more voltage meters, and/or one or more frequency meters and/or temperature meters and/or humidity meters and/or cables and/or power dividers and/or relays and/or passive components; e.g., one or more smart devices which have a built-in functionality to report one or more information items uniquely identifying the smart device and/or one or more “manual devices” which do not have a built-in functionality to report information items to uniquely identify the “Manual device” but are combined or associated with a local storage device having stored such information items), and at least one local storage device. The method comprises:

automatically reading out a plurality of information items, e.g., uniquely, identifying the measurement system components, e.g., a type identifier and/or a serial number, and/or representing one or more characteristics of the measurement system components, e.g., a software revision and/or a calibration date and/or a calibration interval, e.g., in order to obtain a summary file associated with a current measurement system or a “current combination”, automatically reading reference Summary Data, e.g., represented by a (reference) summary file, and a signature, e.g., represented by a signature file, associated with the reference summary data (e.g., associated with the (reference) summary file), from the at least one local storage device of the measurement system; and comparing current summary data, e.g., a summary file associated with the current measurement system or a “current combination”, which is based on the read out information items, or at least a plurality of information items of the current summary data, e.g., such information items which are needed to uniquely identify a measurement system component and those characteristics of the measurement system component which need to remain unchanged, with the reference summary data, or at least with a plurality of information items of the reference summary data, e.g., in order to obtain a component equality information as an intermediate information, and verifying, e.g., performing “signature check”, an authenticity of the reference summary data using the signature, e.g., in order to obtain a signature check information as an intermediate information, in order to obtain a measurement system integrity information, e.g., wherein the measurement system integrity information may, for example, be obtained on the basis of the component equality information and the signature check information.

This embodiment is based on the finding that an integrity of the measurement system can be ensured by using the reference data collected at an earlier time for each component of the measurement system and for the measurement system as a whole as a model for checking whether the parameters of the measurement system and its components were not changed without authorization prior to intended operating the measurement system by a user.

The method may optionally include automatically combining the read out information items, e.g., a serial number, a type identifier, a software revision, a calibration date, a calibration interval etc. of each of the plurality of the measurement system components into a data collection which is represented by actual summary data, e.g., a summary file. Combining the information items in one data collection simplifies storing the information items and its comparison with the reference values.

According to an embodiment, the method further comprises reporting (e.g., to a user, e.g., using a user interface), and/or e.g., storing, the measurement system integrity information, e.g., indicating an integrity of the current state of the measurement system and including e.g., a date of obtaining the measurements system integrity information. The measurements system integrity information may be used to take a decision on whether the measurement system could be used in a current state and/or as a trigger to further blocking the measurement system to avoid operating the measurement system which was changed without an authorization.

According to an embodiment, the method further comprises automatically blocking the measurement system in case the measurement system integrity information contains am information on a non-integrity status of the measurement system. This allows to avoid operating the measurement system which was changed without an authorization and minimize measurement errors due to improper operation of the measurement system and its components.

According to an embodiment, the measurement system is a calibration equipment, configured to calibrate production equipment, e.g., an automated test equipment. Thus, it can be ensured that the production equipment is reliably calibrated.

According to an embodiment, the method comprises selectively certifying a validity of a calibration of the production equipment, e.g., of the automated test equipment, which is performed using the measurement system, in dependence on the measurement system integrity information, such that an integrity of the calibration of the production equipment is certified if a state of the measurement system is in agreement with a state defined by the reference summary data.

According to an embodiment, the method further comprises obtaining a certificate confirming that the production equipment was properly calibrated in response to finding out that the measurement system used for the calibration of the production equipment was unchanged when compared to a reference state.

According to an embodiment, obtaining the certificate is performed by the measurement system and/or by a remote server. This certificate could, for example, be issued by a remote server of the manufacturer of the measurement system.

According to an embodiment, the method further comprises automatically sending the measurement system integrity information to a remote server, e.g., to be stored on the remote server, e.g., to the server operated by the provider (company) of the measurement system.

This allows the manufacturer to control whether his measurement equipment is used under appropriate conditions and to certify reliability of the measurement equipment, or of equipment calibrated using the measurement equipment (or measurement system).

According to an embodiment, a subset of the measurement system components represents one or more of the measurement system components that do not have a built-in functionality to report the information items to identify the one or more of the measurement system components. Accordingly, one or more of measurement system components which do not have a built-in functionality to report information items to, e.g., uniquely, identify the respective measurement system components, e.g., measurement system components that are configured to be read manually, and not automatically, which are not tracked automatically; e.g., passive measurement system components, like cables, switches, relays, power splitters, shielding equipment, connectors, adaptors, and so on, or older measurement devices which do not allow for e readout of a unique identifier like a serial number via an external communication interface, are associated or combined with associated local storage devices to enable automatically reading out measurement system component specific information items identifying the measurement system components which do not have a built-in functionality to report information items to, e.g., uniquely, identify the respective measurement system components. Combining or associating the components with local storage devices having communication interfaces allows automatic tracking of the state of the measurement equipment, which generally cannot be tracked automatically, thus enabling automatically reading out the information items identifying all the components of the measurement system without involvement of the user.

According to an embodiment, a subset of measurement system components represents one or more of the measurement system components that do not have a built-in functionality to report the information items to identify the one or more of the measurement system components. Accordingly, the method comprises associating or combining the measurement system components which do not have a built-in functionality to report information items to, e.g., uniquely, identify the respective measurement system components with the associated local storage devices prior to automatically reading out the information items, e.g., uniquely, identifying the respective measurement system components. Automatic collecting of the parameters of all the components of the measurement system at the same time during the reading out step is thus provided.

According to an embodiment, the measurement system components which do not have a built-in functionality to report information items to, e.g., uniquely, identify the respective measurement system components are inseparably associated or combined with associated local storage devices. This allows exchanging the respective measurement system component together with the respective local storage device and ensuring that automatic reading of all the components is enabled even upon replacing the respective component.

According to an embodiment, the measurement system components which do not have a built-in functionality to report information items to, e.g., uniquely, identify the respective measurement system components are associated or combined with respective associated local storage devices in such a manner that the measurement system components cannot be separated from the respective associated local storage devices in a toolless manner, or the measurement system components which do not have a built-in functionality to report information items to, e.g., uniquely, identify the respective measurement system components are associated or combined with respective associated local storage devices in such a manner that the measurement system components cannot be separated from the respective associated local storage devices in a nondestructive manner, or the measurement system components which do not have a built-in functionality to report information items to, e.g., uniquely, identify the respective measurement system components are associated or combined with respective associated local storage devices in such a manner that the measurement system components cannot be separated from the respective associated local storage devices without breaking a seal.

According to an embodiment, at least one of the measurement system components which do not have a built-in functionality to report information items to, e.g., uniquely, identify the respective measurement system components is glued to a respective one of the local storage devices.

According to an embodiment, at least one of the measurement system components which do not have a built-in functionality to report information items to, e.g., uniquely, identify the respective measurement system components is arranged in a separate housing, e.g., box, cover, with a respective one of the local storage devices. The separate hardware unit with a communication interface is thus provided, which comprises the measurement system component and the local storage device with the communication interface.

According to an embodiment, the one or more of respective local storage devices are one of the following: a USB storage device, a Network attached storage device, a wired-LAN storage device, a wireless-LAN storage device, or an RFID tag. These storage devices are the examples of the storage device to be used. Any other storage device could be used in this embodiment.

According to an embodiment, the one or more measurement system components which do not have a built-in functionality to report information items to, e.g., uniquely, identify the respective measurement system components comprise one or more, e.g., active, measurement devices, e.g., measurement devices configured to report a measurement result via an external interface, e.g., to a measurement system controller. Particularly, the older measurement devices not having communication interfaces could be used in this way.

According to an embodiment, the one or more measurement system components which do not have a built-in functionality to report information items to, e.g., uniquely, identify the respective measurement system components comprise one or more passive measurement system components, e.g., signal path components, passive switches, relays, attenuators, connectors, adaptors, cables, sensors. Reading out the information on the passive measurement system components allows tracking the state of the measurement system as a whole and considering any fluctuations, e.g., voltage and resistance in the connection lines between the components.

According to an embodiment, the one or more measurement system components, which do not have a built-in functionality to report information items to, e.g., uniquely, identify the respective measurement system components comprise one or more of the following measurement system components: signal path components, coupling components, couplers, adapters, or cables.

According to an embodiment, the one or more measurement system components which do not have a built-in functionality to report information items to, e.g., uniquely, identify the respective measurement system components comprise one or more of the following measurement system components: thermodynamic components, fixed power supply components, antennas, shielding housing components, or cooling components, e.g., fans, e.g., aerodynamic characteristics of the fans.

According to an embodiment, the method comprises automatically reading out information items identifying the one or more measurement system components which do not have a built-in functionality to report information items to, e.g., uniquely, identify the respective measurement system components from respective local storage devices, e.g., local memories, associated with the one or more measurement system components which do not have a built-in functionality to report information items to, e.g., uniquely, identify the respective measurement system components, and automatically including the read out information items, e.g., a serial number, a type identifier, a software revision, a calibration date, a calibration interval, etc., of the one or more measurement system components which do not have a built-in functionality to report information items to, e.g., uniquely, identify the respective measurement system components into the data collection.

An embodiment according to the disclosure creates a method for controlling operation of a measurement system comprising a plurality of measurement system components and at least one local storage device, wherein the method comprises protecting the measurement system from unauthorized changes according to any of the above described embodiments, and checking an integrity of the measurement system according to any of the above described embodiments.

An embodiment according to the disclosure creates a measurement system comprising a plurality of measurement system components and at least one local storage device, configured to perform the methods according to any of the previously described embodiments.

An embodiment according to the disclosure creates a computer program having a program code for performing, when running on a computer, methods according to any of the previously described embodiments.

An embodiment according to the disclosure is directed to a computer-readable storage device storing a computer program having a program code for performing the methods according to any of the embodiments described above. Also, the computer-readable storage device includes a plurality of computer-executable instructions stored therein for performing the methods of testing the component.

These and further advantageous aspects are the subject of the dependent claims.

The methods and the measurement system described above may optionally be supplemented by any of the features, functionalities and details disclosed herein (in the entire document), both individually and taken in combination.

This summary is provided to introduce a selection of principles of the disclosure in a simplified form that are further described below in the Detailed Description section. This summary is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated in and form a part of this specification, illustrate embodiments, together with the description, serve to explain the principles of the disclosure.

Embodiments of the present disclosure are set out below in the figures.

FIG. 1 shows a flow chart of a method of protecting a measurement system from unauthorized changes in accordance with an embodiment.

FIG. 2 shows a flow chart of a method of checking an integrity of a measurement system in accordance with an embodiment.

FIG. 3 shows a flow chart of a method of determining whether a measurement system including a plurality of measurement components is used in a valid state in accordance with an embodiment.

FIG. 4 shows a flow chart of a method of supporting a determination whether a measurement system including a plurality of the measurement system components is used in a valid state in accordance with an embodiment.

FIG. 5 shows a schematic representation of a measurements system used as a calibration equipment for calibration of a production equipment in accordance with an embodiment.

FIG. 6 shows a schematic representation of a procedure of creating a signature in accordance with an embodiment.

FIG. 7 shows a schematic representation of a procedure of verifying an authenticity of a data file in accordance with an embodiment.

FIG. 8 shows a schematic representation of a procedure of enabling automatically reading out measurement system component specific information items that identify measurement system components, which do not have a built-in functionality to report information items to identify the respective measurement system components, in accordance with an embodiment.

FIG. 9 shows a method of protecting a measurement system from unauthorized changes in accordance with an embodiment of the disclosure.

FIG. 10 shows a method of checking an integrity of a measurement system in accordance with an embodiment of the disclosure.

### DETAILED DESCRIPTION

Reference will now be made in detail to embodiments, examples of which are illustrated in the accompanying drawings. While the disclosure will be described in conjunction with these embodiments, it should be understood that they are not intended to limit the disclosure to these embodiments. On the contrary, the disclosure is intended to cover alternatives, modifications, and equivalents, which may be included within the spirit and scope of the disclosure as defined by the appended claims. Furthermore, in the following detailed description, numerous specific details are set forth in order to provide a thorough understanding. However, it will be recognized by one of ordinary skill in the art that embodiments may be practiced without these specific details.

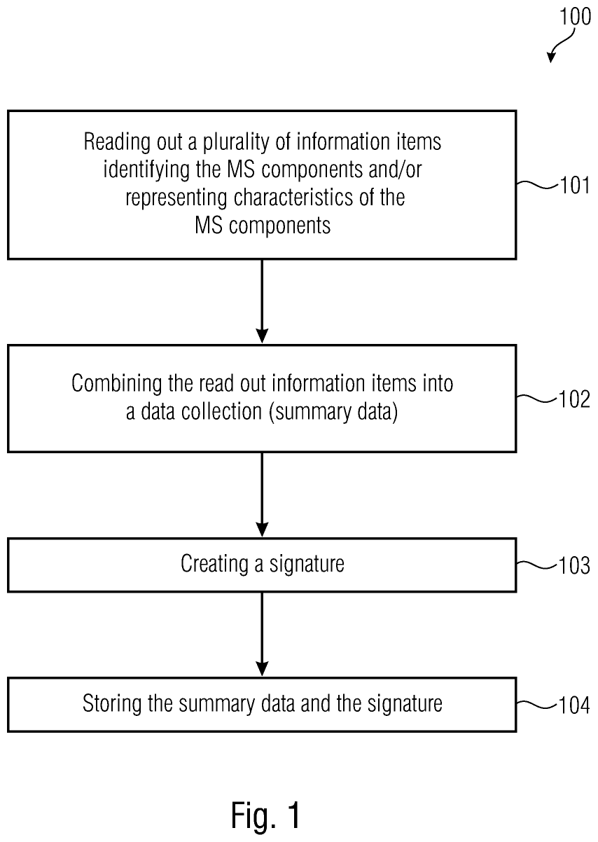

FIG. 1 shows a method 100 of protecting a measurement system having a plurality of measurement system components and at least one local storage device from unauthorized change in accordance with an embodiment of the disclosure. The measurement system components may include such measurement components as e.g., voltage meters, frequency meters, temperature meters, humidity meters. The measurement system components may include connecting components, for example cables. The measurement system components may include e.g., one or more of: power dividers, relays, passive components. The measurement system components may further include, for example, one or more smart devices which have a built-in functionality to report one or more information items uniquely identifying the smart device. The measurement system components may also include one or more so called “manual devices” which do not have a built-in functionality to report information items to uniquely identify these devices. A subset of measurement system components represents one or more of the measurement system components that do not have a built-in functionality to report the information items to identify the one or more of the measurement system components. Such “manual devices” may, for example, be associated or combined with a local storage device having stored such information items.

The method of protecting a measurement system starts at step 101 by automatically reading out a plurality of information items, for example uniquely, identifying the measurement system components and/or representing one or more characteristics of the measurement system components. A read out mechanism could be provided in the measurement system itself to perform the automatic reading step. Alternatively, an external read out device could be used to automatically read out and collect all the information items. The information items identifying the measurement system components could include, for example, a type identifier and a serial number of the respective component. The information items representing one or more characteristics of the measurement system components could, for example, include a software revision date, a software version, a calibration date, a calibration interval, etc.

The method further proceeds with automatically combining the read out information items at step 102, e.g., using a combiner or a combining unit provided in the measurement system or outside of the measurement system. The information items of each of the plurality of the measurement system components are automatically combined at step 102 into a data collection. The data collection is represented by summary data, which may be stored, for example, as a summary file, or a summary data file. At step 103 a signature, to be stored as e.g., a signature file, is created on the basis of the summary data. The signature could be created, for example, using an openSSL toolkit, e.g., using a confidential private key.

However, other signature generating concepts may also be used. Generally speaking, a signature is a cryptographic information which confirms, in a cryptographically reliable manner (fulfilling a desired reliability criterion) that the summary data was generated by a certain (trustworthy) person or entity and that the summary data was not altered in the meantime. Worded differently, the signature may be considered as an information for verifying the authenticity of digital messages or documents (e.g., of the summary data). A valid digital signature, where the prerequisites are satisfied, gives a recipient very strong reason to believe that the message (e.g., the summary data) was created by a known sender (authentication), and that the message was not altered in transit (integrity).

At step 104 the summary data and the signature are stored in the at least one local storage device of the measurement system. The signature and the summary data could be stored in two separate file, e.g., a summary file and a signature file, or in one file. The method ends.

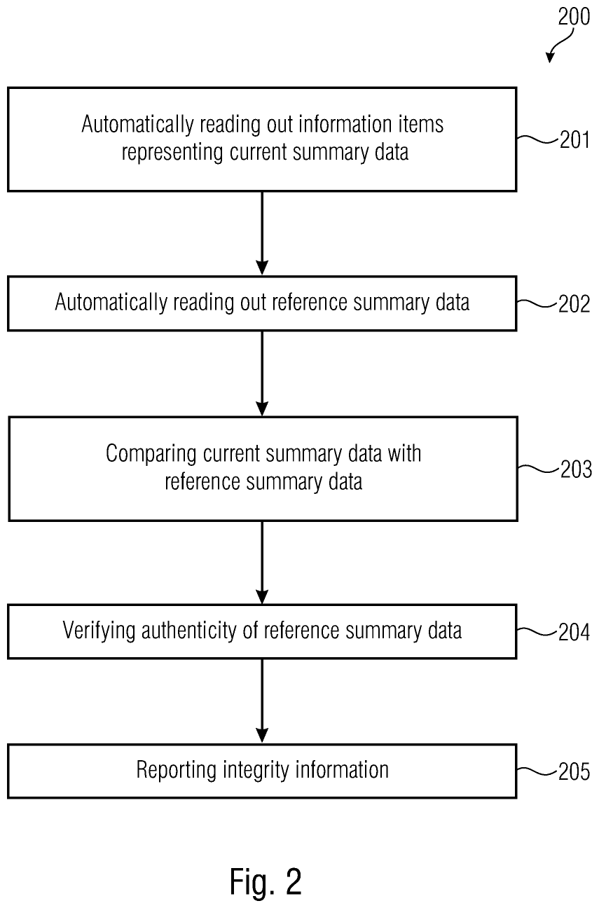

The method 100 allows for a provision of an information (e.g., the summary data and the associated signature), which allows for a check of the integrity of the measurement system (e.g., using the method of FIG. 2). In other words, the summary data and the corresponding signature may serve as input data, e.g., as a reference summary data and a signature associated with the reference summary data, of the method according to FIG. 2.

However, it should be noted that the method 100 may optionally be supplemented by any of the features, functionalities and details disclosed herein, both individually or taken in combination.

FIG. 2 shows a method 200 for checking an integrity of a measurement system comprising a plurality of measurement system components and at least one local storage device in accordance with an embodiment of the disclosure. For example, the method may be used to check the integrity of the measurement system mentioned in the discussion of FIG. 1. For example, the method may be used to check whether the measurement system mentioned in the discussion of FIG. 1 has remained unchanged. The measurement system components may, for example, include such measurement components as e.g., voltage meters, frequency meters, temperature meters, humidity meters. The measurement system components may include connecting components, for example cables. The measurement system components may, for example, include e.g., one or more of: power dividers, relays, passive components. The measurement system components may further include one or more smart devices which have a built-in functionality to report one or more information items uniquely identifying the smart device. The measurement system components may also include one or more so called “manual devices” which do not have a built-in functionality to report information items to uniquely identify these devices. A subset of measurement system components represents one or more of the measurement system components that do not have a built-in functionality to report the information items to identify the one or more of the measurement system components. Such “manual devices” may, for example, be associated or combined with a local storage device having stored such information items.

The methods starts at step 201 by automatically reading out a plurality of information items, for example uniquely, identifying the measurement system components and/or representing one or more characteristics of the measurement system components. A read out mechanism could be provided in the measurement system itself to perform the automatic reading step.

Alternatively, an external read out device could be used to automatically read out and collect all the information items. The information items identifying the measurement system components could include, for example, a type identifier and a serial number of the respective component. The information items representing one or more characteristics of the measurement system components could, for example, include a software revision date, a software version, a calibration date, a calibration interval, etc.

The read out information items could be used e.g., in order to obtain a summary file associated with a current measurement system or a current combination of the measurement system components. In this example, the read out information items of each of the plurality of the measurements system components are automatically combined into a data collection which is represented by actual summary data, e.g., stored into a summary file.

At step 202 the method proceeds with automatically reading reference Summary Data, which could be represented e.g., by a reference summary file, and a signature, which could be represented by a signature file, associated with the reference summary data, e.g., associated with the reference summary file, from the at least one local storage device of the measurement system. However, the reference summary data and the associated signature may also be obtained from a single file in which both data items are included.

The reference summary data and the signature could, for example, be created and stored in the at least one local storage device by the steps of the method 100 shown in FIG. 1.

The method further proceeds with comparing at step 203 the current summary data, which is based on the read out information items, or at least a plurality of information items of the current summary data, with the reference summary data, or at least with a plurality of information items of the reference summary data. The plurality of information items of the current summary data chosen for comparing could include, for example, such information items which are needed to uniquely identify a measurement system component and those characteristics of the measurement system component which need to remain unchanged (e.g., a calibration date, e.g., to ensure that there is no unauthorized calibration by a (non-trustworthy) third party). The comparing is performed, for example, in order to obtain a component equality information as an intermediate information. In case the read out information items were combined into the data collection, such as the summary file, at step 203 comparing of the summary file with the reference summary file is performed.

The method verifies at step 204 an authenticity of the reference summary data using the signature, e.g., by performing a signature check. The signature check could be performed, for example, by an openSSL toolkit, e.g., using a public key corresponding to a private key used to create a signature. This verifying step is performed, for example, in order to obtain a signature check information as an intermediate information.

Steps 203 and 204 are performed in order to obtain a measurement system integrity information, for example, on the basis of the component equality information and the signature check information. The measurement system integrity information shows whether any of the measurement system components were replaced and/or whether their parameters were changed after the last use of the measurement system or after its manufacturing (or assembly) and calibration by the manufacturer. The measurement system integrity information could be further reported at step 205 to the user of the measurement system or to the manufacturer of the measurement system (e. using a user interface or using an electronic message). The measurement system integrity information could be also used as a trigger for further blocking the measurement system so that no further use of the measurement system with changed integrity is possible.

However, it should be noted that the method 200 may optionally be supplemented by any of the features, functionalities and details disclosed herein, both individually or taken in combination.

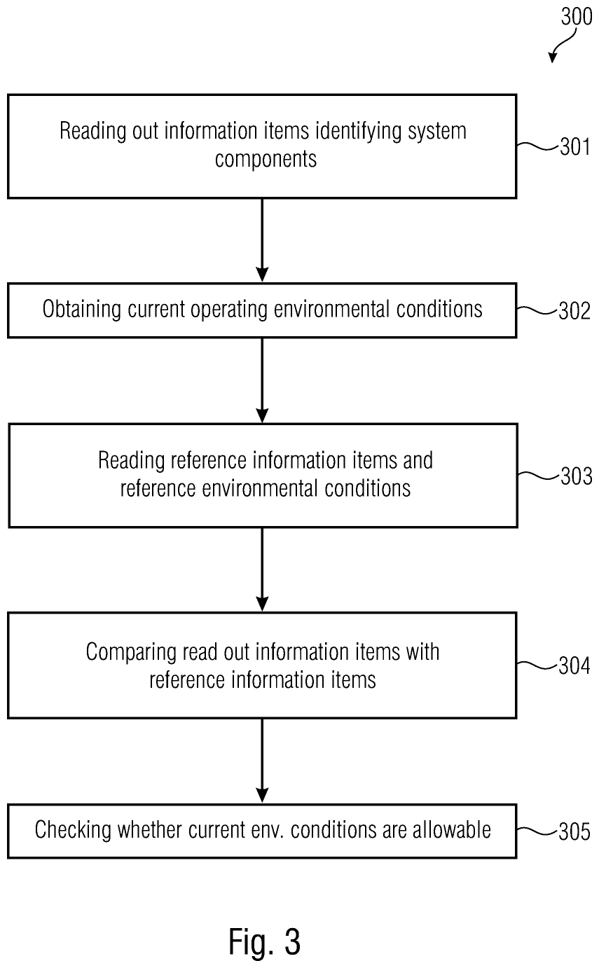

FIG. 3 shows a method 300 for determining whether a measurement system comprising a plurality of measurement components is used in a valid state in accordance with an embodiment of the disclosure.

The method in accordance with this embodiment considers the integrity of the measurement system and also the (relevant) environmental conditions in which the measurement system is used to determine whether the measurement system could be validly used, e.g., without erroneous measuring results coming from the calibration errors and/or the environmental influence (e.g., of the humidity or temperature of the environment). Unknown effects of environmental conditions on the measurements results are avoided in this embodiment.

The method starts with reading out at step 301 a plurality of information items, e.g., uniquely, identifying the measurement system components and/or representing one or more characteristics of the measurement system components. A read out mechanism could be provided in the measurement system itself to perform the automatic reading step. Alternatively, an external read out device could be used to automatically read out and collect all the information items. The information items identifying the measurement system components could include, for example, a type identifier and a serial number of the respective component. The information items representing one or more characteristics of the measurement system components could, for example, include a software revision date, a software version, a calibration date, a calibration interval, etc.

At step 302 the method proceeds with automatically obtaining information on current operating environmental conditions for the measurement system. The information could be obtained by measuring environmental conditions, e.g., using a measurement device being a part of the measurement system, for example a temperature sensor, a humidity sensor or an electromagnetic radiation sensor. The information on different current operating environmental conditions could be thus received, for example a temperature information, and/or a humidity information, and/or an electromagnetic interference information.

At step 303 the method proceeds with automatically reading reference information items, e.g., uniquely, identifying the measurement system components and/or representing one or more characteristics of the measurements system components and information on reference operating environmental conditions. The reference operating environmental conditions could, for example, be determined by manufacturer of the measurement system or separate components of the measurements system based on possible effects of environmental conditions. The reference operating environmental conditions could be defined as allowable values, e.g., of temperature or electromagnetic radiation or humidity, but most often as an allowable range of these parameters. The allowable range is a range within which the measurement system operates without unexpected errors and considerable fluctuations of the measurement results. Thus, the information about the reference operating environmental conditions could, for example, comprise an information describing a minimum allowable temperature and a maximum allowable temperature (e.g., in the form of a minimum value and a maximum value, or in the form of a target value and a tolerance value).

The method further proceeds with comparing at step 304 the read out information items, e.g., uniquely, identifying the measurement system components and/or representing one or more characteristics of the measurement system components with the reference information items, e.g., uniquely, identifying the measurement system components and/or representing one or more characteristics of the measurement system components.

At step 305 the method checks whether the current operating environmental conditions comprise an allowable value or are within an allowable range defined by the information on the reference operating environmental conditions.

Steps 304 and 305 are performed in order to determine whether the measurement system comprising the plurality of measurements system components is used in the valid state. The result of the determination could be reported to a user, for example using a user interface. Alternatively, the result of the determination could be reported using an electronic message. Blocking, e.g., automatically, of the measurement system could be performed in response to the determination that the measurements system is used in invalid state.

A certificate on a validity state of the measurement system could be issued upon the completion of the method 300 in case it was determined that the measurement system is used in the valid state. The certificate could further contain the date and time of performing the method as well as the current state of the measurements system and current operating environmental conditions.

However, it should be noted that the method 200 may optionally be supplemented by any of the features, functionalities and details disclosed herein, both individually or taken in combination.

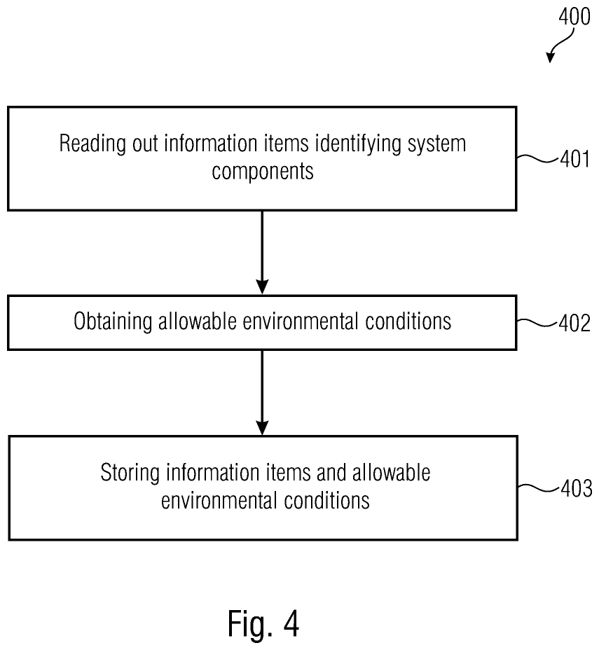

FIG. 4 shows a method 400 to support a determination whether a measurement system comprising a plurality of the measurement system components is used in a valid state, in accordance with an embodiment of the disclosure.

The method starts at step 401 by automatically reading out a plurality of information items, e.g., uniquely, identifying the measurement system components and/or representing one or more characteristics of the measurement system components. A read out mechanism could be provided in the measurement system itself to the perform automatic reading step. Alternatively, an external read out device could be used to automatically read out and collect all the information items. The information items identifying the measurement system components could include for example a type identifier and a serial number of the respective component. The information items representing one or more characteristics of the measurement system components could, for example, include a software revision date, a software version, a calibration date, a calibration interval, etc.

At step 402 the method proceeds with obtaining information on allowable operating environmental conditions for the measurement system. Obtaining may include e.g., reading from the user interface or reading from a memory associated with a measurement system component, or e.g., collecting, or e.g., automatically obtaining. Allowable operating environmental conditions include e.g., an allowable temperature range and/or an allowable humidity range and/or an allowable maximum electromagnetic interference. Allowable operating environmental conditions could, for example, correspond to (e.g., be equal to, or be in an interval around) the environmental conditions which have been used in calibration of the measurement system (e.g., by the manufacturer, or by a trustworthy entity, or deviate from environmental conditions used in calibration of the measurement system by no more than an allowable tolerance.

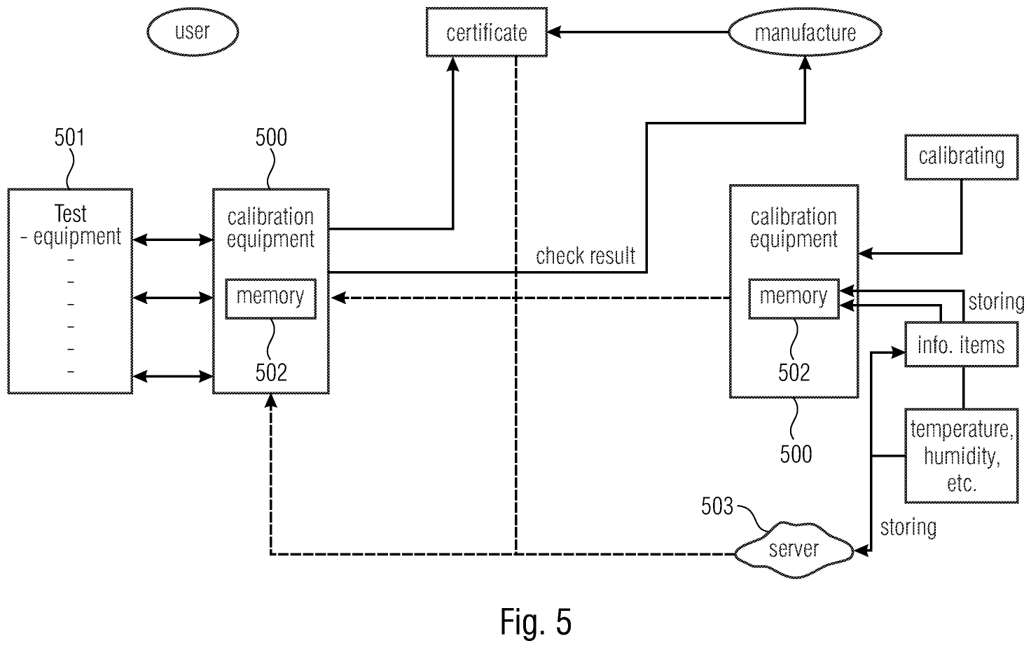

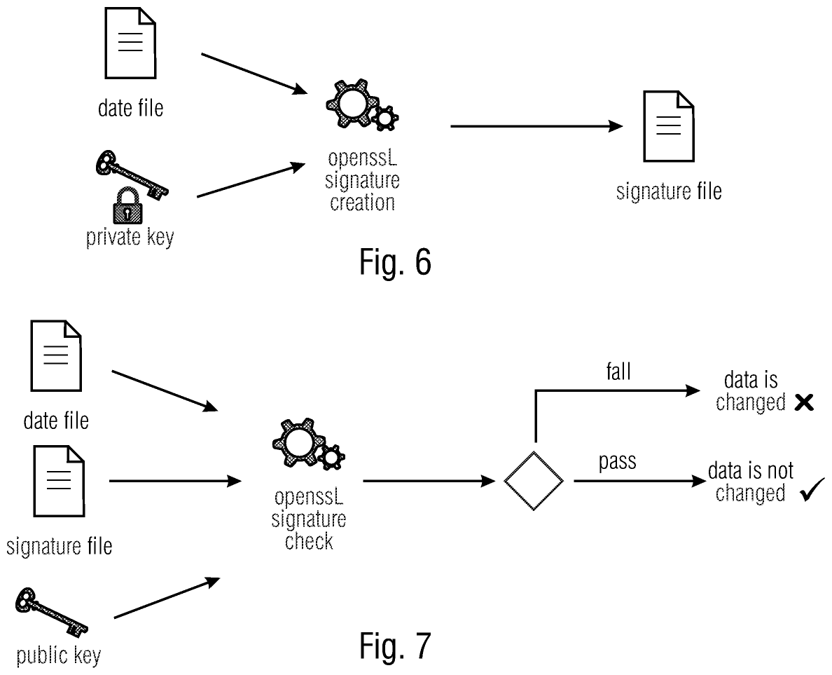

The information on the allowable operating environmental conditions may be signed, e.g., a signature may be created and stored, e.g., in the at least one local storage device of the measurement system. A procedure of creating a signature, for example, as described with reference to FIG. 6, may be used for signing.

The method ends at step 403 by storing the information items identifying the measurements system components and/or representing one or more characteristics of the measurements system components and the information on the allowable operating environmental conditions for use in the determination whether the measurement system comprising the plurality of measurement system components is used in the valid state.

The stored information could be further used as a reference information upon performing the method shown in FIG. 3.

However, it should be noted that the method 400 may optionally be supplemented by any of the features, functionalities and details disclosed herein, both individually or taken in combination.

FIG. 5 shows an embodiment where the measurement system (e.g., the measurement system mentioned above in the discussion of the methods of FIGS. 1 to 4) is used as a calibration equipment for calibration of a production equipment. As shown in FIG. 5 the calibration equipment 500 is, for example, calibrated at a manufacturer side (or, generally, at the side of a trustworthy entity) and delivered to a user. The user is at the same time a user of an automated test equipment 501, e.g., previously also bought (or rented) from the manufacturer.

The reference information items defining the calibration equipment 500 and the allowed operating environmental conditions (e.g., as determined using the method according to FIG. 1 or according to FIG. 4) are stored at the local storage device 502, e.g., memory, of the calibration equipment 500 (e.g., by the manufacturer, or by another trustworthy entity).

Additionally, the reference information items and the allowed operating environmental conditions are optionally stored in the remote server 503 of the manufacturer, e.g., in the cloud, to be used as a back-up in case the local storage device 502 is broken or does not function properly.

When the user uses the calibration equipment 500 to calibrate the automated test equipment 501, the validity state of the calibration equipment 500 is checked at the calibration equipment 500. This check may, for example, be performed using the method 200 according to FIG. 2 or using the method according to FIG. 3. Alternatively, however, the check may, for example, use a combination of the methods of FIGS. 2 and 3, wherein the method according to FIG. 2 may be supplemented by a check of the environmental operating conditions in accordance with the method of FIG. 3. If it is confirmed (e.g., in the check steps 203 and 204 of the method of FIG. 2, and in the check steps 304 and 305 of the method of FIG. 3) that the calibration equipment 500 is used in the valid state a certificate confirmation (or an electronic message, or a message on a user interface) that the calibration equipment 500 is used in the valid state could be issued by the calibration equipment 500 itself or by the manufacturer based on the result of the determination whether the calibration equipment 500 is used in the valid state, the result is provided to the manufacturer by the calibration equipment 500.

For example, the method could comprise checking

a) whether the automated test equipment has been calibrated using the measurement system within predetermined required intervals (e.g., once per specified period of time, or once per specified number of tests, or according to any other requirement rule); and

b) whether the measurement system was “in good order” (i.e., not modified when compared to a reference state and/or operated at allowable environmental operating conditions) when calibrating the automated test equipment.

From such a check, it can be concluded that the automated test equipment was reliable when testing one or more devices under test. Thus, the certificate confirmation (which may, for example be provided in electronic form or in a printed form, or in any other appropriate form) may, for example, indicate the reliability of the automated test equipment at a certain time or when testing a certain batch of devices under test.

However, it should be noted that the system of FIG. 5 may optionally be supplemented by any of the features, functionalities and details disclosed herein, both individually or taken in combination.

FIG. 6 shows a procedure of creating a signature used as a step, e.g., in the method shown in FIG. 1 (and/or, optionally, in the method of FIG. 4). The data file, e.g., the summary file including the summary data, and a private key, e.g., a confidential private key, are used, for example, by an openSSL toolkit (or any other signature method) to create a signature based on the summary data. The data file is then signed by the created signature to protect its content (e.g., in the sense that it is possible to check authenticity and/or integrity of the data file using the signature). The signature is stored in the signature file. The signature and the signed data could be also stored in one file (not shown).

This signature (or signation) procedure is used to prohibit data, e.g., in the data file, e.g., the summary data, and/or the information describing the allowed environmental operating conditions, from being changed without the change being discovered. After the signature (or signature file) and the signed data file are stored, the signature (or the signature file), e.g., the signature stored in the signature file, could be used to verify an authenticity and/or integrity of the data file stored, e.g., to check whether the data file and/or the signature file was changed, as will be shown in FIG. 7.

To conclude, the signature process according to FIG. 6 may optionally be used in any of the methods and apparatuses disclosed herein, e.g., in order to allow for checking the authenticity and/or integrity of the summary file and/or of the information on the allowable environmental operating conditions.

However, it should be noted that the method of FIG. 6 may optionally be supplemented by any of the features, functionalities and details disclosed herein, both individually or taken in combination.

FIG. 7 shows a procedure of verifying an authenticity of the data file, e.g., containing reference summary data and/or information on the allowable environmental operating conditions, which is used, for example, in the method shown in FIG. 2 to check an integrity of a measurement system. The procedure of FIG. 7 many optionally be used in the method of FIG. 3 to check the authenticity and integrity of the information about the allowable environmental operating conditions.

As shown in FIG. 7, the match of the data file and the signature file is verified to check whether signed data and/or the signature of that data was changed since signation (or since signature). To check this match an openSSL toolkit (or any other signature check method) is used to perform a signature check using the stored data filed, the signature file and the public key (associated with the person or entity generating the signature using its private key). The public key corresponds to the private key which was used at signation (or signature), as shown in FIG. 6.

If the signature check is successful, e.g., pass result of the signature check is provided (or received), and the report that data is not changed (and/or authentic, i.e., generated by a trustworthy entity) is provided to the measurement system or other entity requesting the signature check to be performed. If the signature check failed, e.g., fail result of the signature check is received, the report that data is changed is provided to the measurement system or other entity requesting the signature check. Based on the report on the signature check result the measurement system integrity information may be provided (or received), e.g., as in the method shown in FIG. 2.

However, it should be noted that the method of FIG. 7 may optionally be supplemented by any of the features, functionalities and details disclosed herein, both individually or taken in combination.

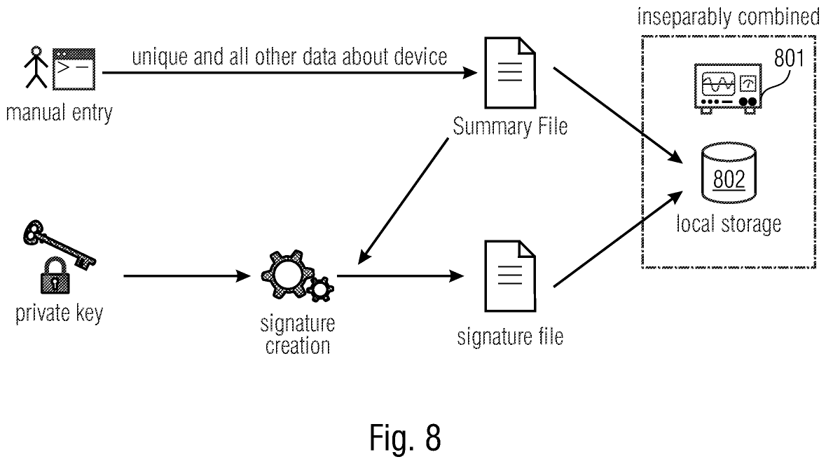

FIG. 8 shows a procedure of enabling automatically reading out measurement system component specific information items identifying the measurement system components, which do not have a built-in functionality to report information items to identify the respective measurement system components. A subset of measurement system components represents one or more of the measurement system components that do not have a built-in functionality to report the information items to identify the one or more of the measurement system components. The measurement system components, which do not have a built-in functionality to report information items to identify the respective measurement system components, are so called “manual” devices, e.g., old measurement equipment, passive components like cables, relays, power splitters, antennas, shielding devices or shielding boxes, etc. As shown in FIG. 8, the “manual” measurement system component 801 is associated or combined with a local storage device 802, e.g., inseparably associated or combined. Inseparably associating or combining could be associating or combining in such a way that the component 801 could not be separated from the local storage device 802 in a toolless manner, in a non-destructive manner, without breaking a seal, etc. The component 801 could be also glued, or welded, or riveted, or crimped, or molded to the local storage device 802. The component 801 could be also arranged in a separate housing, such as a box or under a separate cover together with the local storage device 802. The local storage device 802 could be any storage device, such as a USB storage device, a network attached storage device, an RFID tag, a wired-LAN storage device, a wireless-LAN storage device, etc. This list of storage devices is non-exclusive and any local storage device could be used.

As further shown in FIG. 8, one or more or even all information items uniquely identifying the “manual” component 801, such as a serial number or a type identifier, and/or information items representing one or more characteristics of the “manual” component, such as a software revision or a calibration date or a calibration interval, and any other data characterizing the “manual” device, such as a calibration interval, is (e.g., manually) written into a summary file. The content of the summary file is then signed, for example using a private key, to protect the data stored in the summary file from being changed (e.g., using the signature method described herein). The signation (or signature) procedure is, for example, the same as shown in FIG. 6. The created Signature file and the signed Summary file (or a combined file comprising summary and signature) are stored in the local storage device 802 associated or combined with the “manual” device 801.

Therefore, the measurement system component specific information items identifying the “manual” measurement system components can be read out automatically upon performing any of the methods shown in FIGS. 1-4 and further methods described herein.

To conclude, the method of FIG. 8 may be used to obtain information about “passive” components, which may be used in the other methods disclosed herein (e.g., for checking whether any passive components have been exchanged). In other words, by providing the one or more passive components with corresponding storage devices (e.g., in an inseparable manner), the passive components can be monitored in the same manner as any active components (which are originally equipped to allow for a readout of unique identification information).

However, it should be noted that the method of FIG. 8 may optionally be supplemented by any of the features, functionalities and details disclosed herein, both individually or taken in combination.

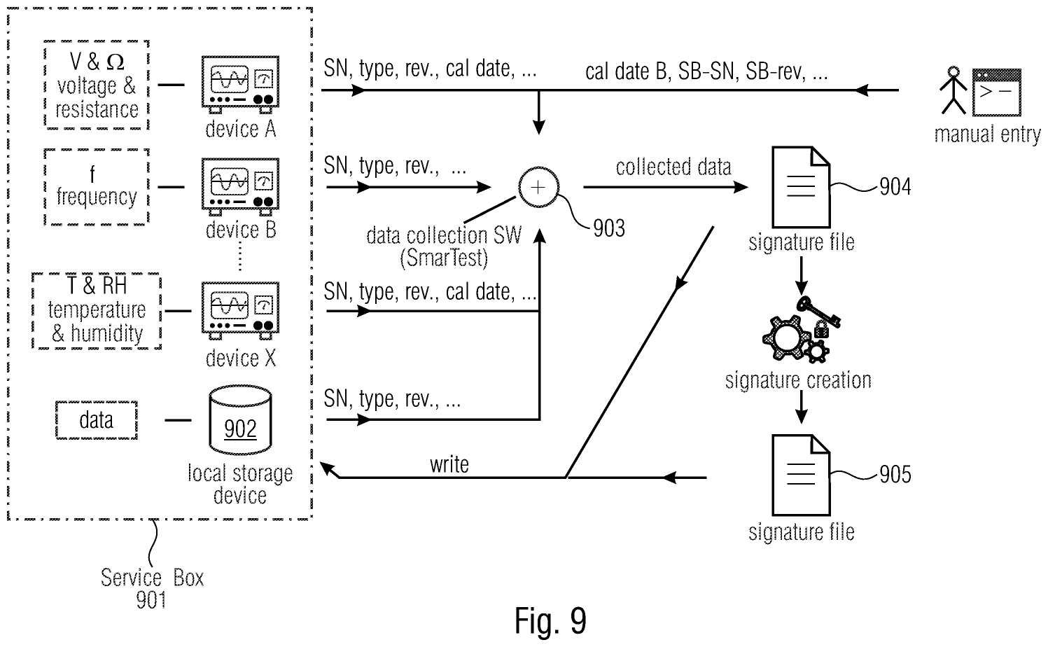

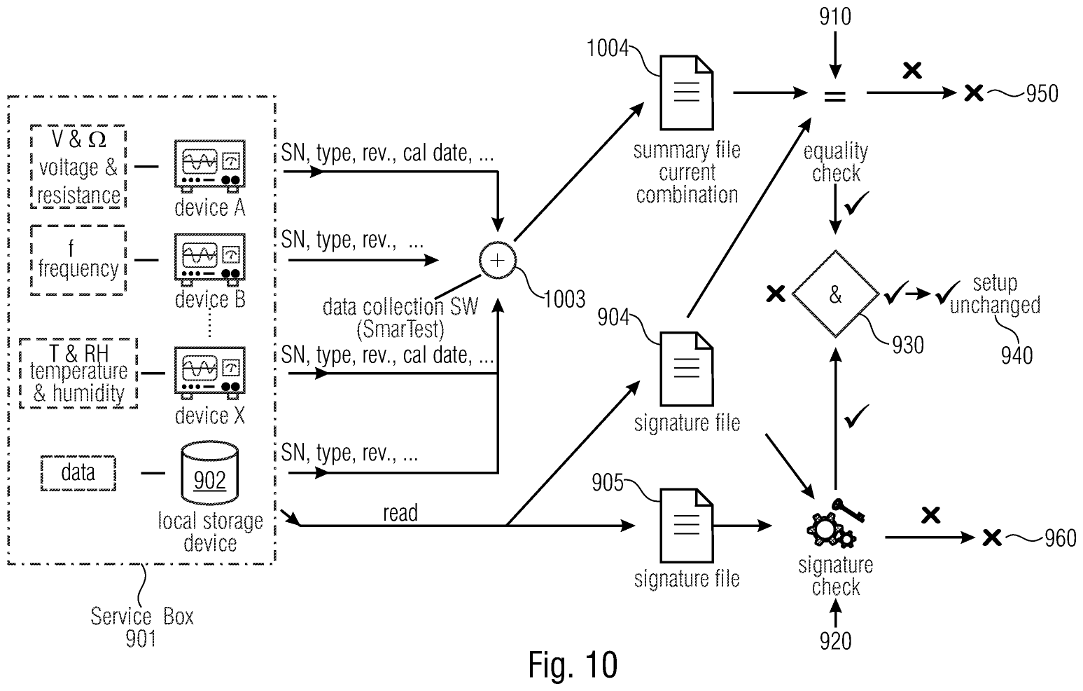

FIG. 9 shows a schematic view of a measurement system comprising a plurality of measurement system components and a method of protecting the measurement system from unauthorized changes in accordance with an embodiment of the disclosure.

The measurement system 901 comprises a plurality of components A to X configured to measure different parameters of the production equipment (e.g., when performing a calibration of an automated test equipment), such as voltage, resistance and frequency. Some of the components are also configured to measure environmental conditions such as temperature or humidity, e.g., device X shown in FIG. 9. For example, there may be one or more components for measuring a temperature of the automated test equipment or in an environment of the automated test equipment, and there may, for example, also be one or more components for measuring a temperature (or any other environmental parameter) of the measurement system itself (or of one or more components of the measurement system itself). The measurement system 901 further comprises a local storage device 902 storing data on the measurement system components. The measurement system components arranged together form a Service Box provided by the manufacturer to the user to be used for measurement purposes, such as e.g., calibration (e.g., of an automated test equipment).

The measurement system components are arranged together by automatically storing their unique data into a Summary File. All the unique data, such as serial numbers, device types, software revisions, calibration dates, calibration intervals of each of the measurement system components are collected into a data collection 903. Some data on the components, e.g., calibration interval, or data on the arranged entity (Service Box), e.g., Service Box serial number, calibration date of the Service Box, or Service Box software revision are, for example, added manually to the data collection.

The data collection is then stored as a summary file 904 in the local storage device 902 of the measurement system 901. To prohibit the data stored in the summary file 904 from being changed, its content is signed by a signature creation procedure, e.g., the one shown in FIG. 6. The signature file 905 is also stored in the local storage device 902 of the measurement system 901. Alternatively, data summary and signature are stored in a single file.

The measurement system 901 is thus protected from unauthorized change and its integrity could be checked by the user during operation.

However, it should be noted that the method of FIG. 9 may optionally be supplemented by any of the features, functionalities and details disclosed herein, both individually or taken in combination.

FIG. 10 shows a procedure for checking an integrity of the measurement system 901, e.g., called a Service Box, shown in FIG. 9. The data on a plurality of parameters of the measurement system components, such as a serial numbers, types of components, software revisions, calibration dates, calibration intervals are read out (e.g., from memories associated individually with the individual measurement system components) and collected into a data collection 1003. The data is read out automatically for the components with in-built functionality to report information items to identify the components. For those components which do not have an (originally) in-built functionality to report information items to identify the components (like, e.g., passive components), the procedure shown in FIG. 8 may, for example, be applied to enable automatically reading out measurement system component specific information items.

The data collection 1003 is represented by a summary file 1004 obtained as a result of automatically combining the read out data and representing a current combination of the measurement system 901.

The summary file 904 and the signature file 905 stored in the local storage device 902 of the measurement system 901 are read out from the local storage device. The summary file 1004 showing the current combination of the measurement system 901 is compared with the summary file 904, being a reference summary file, to perform an equality check 910. If the equality check is not successful, i.e., the current summary file 1004 is not equal to the reference summary file 904, the report 950 is issued that the measurement system state, or the measurement setup, was changed and the measurement system is not in a valid state for operating by the user.

Further to the equality check 910 a signature check 920 is performed to check whether the summary file 904 match the signature file 905. This check shows whether the stored summary file and signature file were changed after their storing in the local storage device 902 by the manufacturer of the measurement system 910. If the signature check 920 is not successful, i.e., the summary file 904 does not match to the signature file 905, the report 960 is issued that the measurement system state, or the measurement setup, was changed and the measurement system is not in a valid state for operating by the user.

If the results of both the equality check 910 and the signature check 920 are positive, the report 940 is issued that the measurement system state, or the measurement setup, is unchanged and the measurement system is in a valid state for operating by the user.

However, it should be noted that the method of FIG. 10 may optionally be supplemented by any of the features, functionalities and details disclosed herein, both individually or taken in combination.

Although some aspects are described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the disclosure can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be a computer-readable storage device. The computer-readable storage device may include a plurality of computer-executable instructions stored therein.

Some embodiments according to the disclosure comprise a data carrier having electronically readable control signals, which are capable of cooperating with a programmable computer system, such that one of the methods described herein is performed.

Generally, embodiments of the present disclosure can be implemented as a computer program product with a program code, the program code being operative for performing one of the methods when the computer program product runs on a computer. The program code may for example be stored on a machine-readable medium.

Other embodiments comprise the computer program for performing one of the methods described herein, stored on a machine-readable medium.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the disclosure comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

The herein described embodiments are merely illustrative for the principles of the present disclosure. It is understood that modifications and variations of the arrangements and the details described herein will be apparent to others skilled in the art. It is the intent, therefore, to be limited by the scope of the Claims appended hereto and their equivalents and not by the specific details presented by way of description and explanation of the embodiments herein.

The foregoing descriptions of specific embodiments have been presented for purposes of illustration and description. They are not intended to be exhaustive or to limit the disclosure to the precise forms disclosed, and many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated. It is intended that the scope of the disclosure be defined by the Claims appended hereto and their equivalents.

What is claimed is:

1. A method of protecting a measurement system from unauthorized changes, the method comprising:
automatically reading out a plurality of information items from the measurement system, wherein the measurement system comprises a plurality of measurement system components and at least one local storage device, wherein the plurality of information items include at least one of identity of the measurement system components or at least one characteristic of the measurement system components;
automatically combining the read out information items of each of the plurality of the measurement system components into a data collection and generating a summary data which represents the data collection;
creating a signature based on the summary data; and
storing the summary data and the signature in the at least one local storage device of the measurement system.

2. The method of claim 1, wherein the creating the signature includes:
signing the summary data with a private key.

3. The method of claim 2, wherein the private key is a confidential private key.

4. The method of claim 1, wherein the storing includes at least one of:
storing the summary data and the signature in separate files, or
storing the summary data and the signature in same file.

5. The method of claim 1, wherein a subset of measurement system components represents one or more of the measurement system components that do not have a built-in functionality to report the information items to identify the one or more of the measurement system components, and further comprising:
associating the subset of measurement system components with one or more of the at least one local storage device to enable automatically reading out the information items that identify the subset of measurement system components.

6. The method of claim 5, further comprising:
associating the subset of measurement system components with one or more of the at least one local storage device prior to automatically reading out the plurality of information items.

7. The method of claim 5, further comprising:
inseparably associating the subset of measurement system components with the one or more of the at least one local storage device.

8. The method of claim 5, further comprising:
performing the associating in a manner to prevent a disassociation of the subset of measurement system components from the one or more of the at least one local storage device by requiring at least one of a tool, a destructive action, or a break of a seal for the disassociation.

9. The method of claim 5, wherein the associating comprises:
gluing at least one from the subset of measurement system components to one from the at least one local storage device.

10. The method of claim 5, wherein the associating comprises:
arranging in a housing at least one from the subset of measurement system components with one from the at least one local storage device.

11. The method of claim 1, wherein the at least one local storage device comprises at least one from a USB storage device, a network attached storage device, a wired-LAN storage device, a wireless-LAN storage device, or an RFID tag.

12. The method of claim 1, wherein a subset of measurement system components represents one or more of the measurement system components that do not have a built-in functionality to report the information items to identify the one or more of the measurement system components, wherein the subset of measurement system components comprises one or more measurement devices.

13. The method of claim 1, wherein a subset of measurement system components represents one or more of the measurement system components that do not have a built-in functionality to report the information items to identify the one or more of the measurement system components, wherein the subset of measurement system components comprises one or more passive measurement system components.

14. The method of claim 1, wherein a subset of measurement system components represents one or more of the measurement system components that do not have a built-in functionality to report the information items to identify the one or more of the measurement system components, wherein the subset of measurement system components comprises at least one from a signal path component, a coupling component, a coupler, an adapter, or a cable.

15. The method of claim 1, wherein a subset of measurement system components represents one or more of the measurement system components that do not have a built-in functionality to report the information items to identify the one or more of the measurement system components, wherein the subset of measurement system components comprises at least one from a thermodynamic component, a fixed power supply component, an antenna, a shielding housing component, or a cooling component.

16. The method of claim 1, wherein a subset of measurement system components represents one or more of the measurement system components that do not have a built-in functionality to report the information items to identify the one or more of the measurement system components, and further comprising:
associating the subset of measurement system components with one or more of the at least one local storage device;
automatically reading out the information items that identify the subset of measurement system components from the one or more of the at least one local storage device; and
automatically including the read out information items that identify the subset of measurement system components from the one or more of the at least one local storage device into the data collection.

17. The method of claim 1, wherein the at least one characteristic of the measurement system components comprises a wear out condition of at least one of the measurement system components.

18. The method of claim 17, wherein the wear out condition comprises a value of a counter which is arranged in a respective measurement system component, and wherein the counter is incremented upon each use of the respective measurement system component.

19. The method of claim 17, further comprising:
performing a self-estimation by a respective measurement system component to determine the wear out condition of the respective measurement system component.

20. The method of claim 1, further comprising:
obtaining information on allowable operating environmental conditions for the measurement system; and
storing the information on the allowable operating environmental conditions in the at least one local storage device of the measurement system.

21. The method of claim 20, wherein the information on allowable operating environmental conditions comprises information on at least one from a humidity, a temperature, or an electromagnetic interference.

22. A method for checking an integrity of a measurement system, the method comprising:
automatically reading out a plurality of information items from the measurement system, wherein the measurement system comprises a plurality of measurement system components and at least one local storage device, wherein the plurality of information items include at least one of identity of the measurement system components or at least one characteristic of the measurement system components;
automatically reading out a reference summary data and a reference signature associated with the reference summary data from the at least one local storage device of the measurement system;
comparing at least one of a current summary data which is based on the read out information items or at least a first plurality of information items of the current summary data with at least one of the reference summary data or at least a second plurality of information items of the reference summary data; and
verifying an authenticity of the reference summary data using the reference signature to obtain a measurement system integrity information.

23. The method of claim 22, further comprising:
reporting the measurements system integrity information.

24. The method of claim 22, further comprising:
automatically blocking use of the measurement system if the measurement system integrity information indicates an invalid status for the measurement system.

25. The method of claim 22, wherein the measurement system comprises a calibration equipment operable to calibrate a production equipment.

26. The method of claim 25, further comprising:
selectively certifying a validity of a calibration, which is performed using the measurement system, of the production equipment based on the measurement system integrity information.

27. The method of claim 25, further comprising:
obtaining a certificate that confirms the production equipment was properly calibrated in response to determining that the measurement system which performed the calibration of the production equipment was unchanged when compared to a reference state.

28. The method of claim 27, wherein the obtaining the certificate is performed by at least one of the measurement system or a remote server.

29. The method of claim 22, further comprising:
automatically sending the measurement system integrity information to a remote server.

30. The method of claim 22, wherein a subset of measurement system components represents one or more of the measurement system components that do not have a built-in functionality to report the information items to identify the one or more of the measurement system components, and further comprising:
associating the subset of measurement system components with one or more of the at least one local storage device to enable automatically reading out the information items that identify the subset of measurement system components.

31. The method of claim 30, further comprising:
associating the subset of measurement system components with one or more of the at least one local storage device prior to automatically reading out the plurality of information items.

32. The method of claim 30, further comprising:
inseparably associating the subset of measurement system components with the one or more of the at least one local storage device.

33. The method of claim 30, further comprising:
performing the associating in a manner to prevent a disassociation of the subset of measurement system components from the one or more of the at least one local storage device by requiring at least one of a tool, a destructive action, or a break of a seal for the disassociation.

34. The method of claim 30, wherein the associating comprises:
gluing at least one from the subset of measurement system components to one from the at least one local storage device.

35. The method of claim 30, wherein the associating comprises:
arranging in a housing at least one from the subset of measurement system components with one from the at least one local storage device.

36. The method of claim 22, wherein the at least one local storage device comprises at least one from a USB storage device, a network attached storage device, a wired-LAN storage device, a wireless-LAN storage device, or an RFID tag.

37. The method of claim 22, wherein a subset of measurement system components represents one or more of the measurement system components that do not have a built-in functionality to report the information items to identify the one or more of the measurement system components, wherein the subset of measurement system components comprises one or more measurement devices.

38. The method of claim 22, wherein a subset of measurement system components represents one or more of the measurement system components that do not have a built-in functionality to report the information items to identify the one or more of the measurement system components, wherein the subset of measurement system components comprises one or more passive measurement system components.

39. The method of claim 22, wherein a subset of measurement system components represents one or more of the measurement system components that do not have a built-in functionality to report the information items to identify the one or more of the measurement system components, wherein the subset of measurement system components comprises at least one from a signal path component, a coupling component, a coupler, an adapter, or a cable.

40. The method of claim 22, wherein a subset of measurement system components represents one or more of the measurement system components that do not have a built-in functionality to report the information items to identify the one or more of the measurement system components, wherein the subset of measurement system components comprises at least one from a thermodynamic component, a fixed power supply component, an antenna, a shielding housing component, or a cooling component.

41. The method of claim 22, wherein a subset of measurement system components represents one or more of the measurement system components that do not have a built-in functionality to report the information items to identify the one or more of the measurement system components, and further comprising:
associating the subset of measurement system components with one or more of the at least one local storage device;
automatically reading out the information items that identify the subset of measurement system components from the one or more of the at least one local storage device; and
automatically combining the read out information items of each of the plurality of the measurement system components into a current data collection and generating the current summary data which represents the current data collection;
automatically including the read out information items that identify the subset of measurement system components from the one or more of the at least one local storage device into the current data collection.

42. A computer-readable storage device comprising a plurality of computer-executable instructions stored therein, wherein the plurality of computer-executable instructions comprise:
instructions to automatically read out a plurality of information items from a measurement system, wherein the measurement system comprises a plurality of measurement system components and at least one local storage device, wherein the plurality of information items include at least one of identity of the measurement system components or at least one characteristic of the measurement system components;
instructions to automatically combine the read out information items of each of the plurality of the measurement system components into a data collection and generating a summary data which represents the data collection;
instructions to create a signature based on the summary data; and
instructions to store the summary data and the signature in the at least one local storage device of the measurement system.

43. A computer-readable storage device comprising a plurality of computer-executable instructions stored therein, wherein the plurality of computer-executable instructions comprise:
instructions to automatically read out a plurality of information items from the measurement system, wherein the measurement system comprises a plurality of measurement system components and at least one local storage device, wherein the plurality of information items include at least one of identity of the measurement system components or at least one characteristic of the measurement system components;
instructions to automatically read out a reference summary data and a reference signature associated with the reference summary data from the at least one local storage device of the measurement system;
instructions to compare at least one of a current summary data which is based on the read out information items or at least a first plurality of information items of the current summary data with at least one of the reference summary data or at least a second plurality of information items of the reference summary data; and
instructions to verify an authenticity of the reference summary data using the reference signature to obtain a measurement system integrity information.
